(19) United States
(12) Patent Application Publication
(10) Pub. No.: US 2012/0155581 A1
(43) Pub. Date: Jun. 21, 2012

(54) IMPLEMENTATION OF A HIGH PERFORMANCE MULTI-CARRIER RECEIVER USING FREQUENCY SELECTIVITY AND DIGITAL COMPENSATION TECHNIQUES

(76) Inventors: Francesco Dantoni, Rome (IT); Roland Sperlich, Dallas, TX (US); Robert C. Keller, Plano, TX (US)

(21) Appl. No.: 13/030,063

(22) Filed: Feb. 17, 2011

Related U.S. Application Data
(60) Provisional application No. 61/425,163, filed on Dec. 20, 2010.

(51) Int. Cl. H04L 27/06

(52) U.S. Cl. 375/344

(57) ABSTRACT

A system has a first branch and a second branch. The system comprises a first intermediate frequency source of the first branch and a first mixer coupled to the first intermediate frequency source. The system has a second intermediate frequency source of the second branch and a second mixer coupled to the second intermediate frequency source. A frequency of the first intermediate frequency source is different than a frequency of the second intermediate frequency source. The system has an amplifier coupled to an input of the first mixer and an input of the second mixer. A first component of an analog to digital converter (“ADC”) is coupled to the first mixer of the first branch. A second component of the ADC is coupled to the second mixer of the second branch.

### CROSS REFERENCE RELATED APPLICATION

This application claims the benefit of U.S. Provisional Application Ser. No. 61/425,163 filed on Dec. 20, 2010, entitled “IMPLEMENTATION OF A HIGH PERFORMANCE MULTI-CARRIER RECEIVER USING FREQUENCY SELECTIVITY AND DIGITAL COMPENSATION TECHNIQUES,” commonly assigned with this application and incorporated herein by reference.

### TECHNICAL FIELD

This Application is directed, in general, to an implementation of a multi-carrier receiver and, more specifically, to an implementation of a multi-carrier receiver using frequency selectivity and digital compensation techniques.

### BACKGROUND

In radio systems, it is advantageous to have receivers that can receive signals at different frequencies. This can be accomplished through a number of different approaches.

A first approach is that a single antenna is coupled to a plurality of “receiver chains”, one receiver chain per desired signal to be received. An advantage of this first approach is that each receiver chain can be designed to be extremely selective for the desired signal, through employment of an analog narrow-band filter that attenuates signals other than the one desired. However, some significant disadvantages of this first approach are price, complexity, and use of significant printed circuit board area.

In a second approach, a single receiver chain is employed, wherein the single receiver chain employs an analog band-pass filter that can pass multiple desired frequencies, which can later be individually selected during digital signal processing.

However, in having such flexibility in the second approach, other concerns are introduced, especially regarding employment of analog to digital converters (“ADC”s.) An ADC has a sampling rate for converting a received analog signal (such as a desired signal “fₛ₁”) into digitized information. However, ADCs have a limited sensitivity. For example, an ADC performance can be specified by a: signal to noise ratio (“SNR”), a spurious-free dynamic range (“SFDR”), and a signal to noise and distortion (“SINAD”). These three parameters may variously be employed to specify an ADC dynamic range. For example, an ADS5493, a type of 16-bit ADC, at 130 mega samples per second (“MSPS”) can have approximately 76 dB of SNR. This maximum sensitivity can be problematic in noisy environments in pass-band single-chain systems.

Another of these concerns of the second approach relates to “blocking signals.” A blocking signal can be generally defined as an unwanted signal that is “close” to a frequency of a desired signal, but not at the “exact” same frequency. A blocking signal can be received as a very high power signal by a radio receiver, as the broadcast power of the blocking signal is not controlled by a receiving communication system. For example an AT&T® system cannot control the power of a T-Mobile® cell phone, which may be very close to the AT&T® base station antenna and therefore the T-Mobile® cell phone can generate a “blocking” signal. Therefore, a radio receiver, such as a base station receiver, is typically designed for a worst-case scenario of receiving a small desired signal in the presence of a large blocking signal.

Even more problematically, there is a “Nyquist frequency” related to a sampling rate of the ADC itself. The Nyquist frequency generally states that any signal sampled that has a frequency that is above half of the sampling frequency of the digital sampler, such as the ADC, is going to be “aliased” or “folded down” and read as a lower frequency signal.

In conventional systems, a receiver chain is designed to try to avoid a pass-band falling across a Nyquist band. However, if a desired passband is too large, and there is not an ADC that can hand so large a bandwidth related to the passband, this can create problems. Other aspects of the Nyquist frequency can also be problematic, in that a blocking signal has harmonics. These harmonics can also be within the part of the passband that is above the Nyquist frequency, but can still fall within the pass-band. These harmonics can then get “folded” back below the Nyquist frequency. In some cases, the folded harmonics can completely block out or overlap the desired signal.

Blocking signals can further interact with the ADC, which can be characterized in part by a figure of merit, the SFDR, to produce an undesired spurious signal (from now referred to as “SFDR spurious” or “SFDR signal”). “SFDR” can be generally defined as the power ratio of the largest signal frequency (maximum signal component) at the input of an ADC or a digital to analog converters (“DAC”) to the largest unwanted signal frequency generated at the ADC or DAC, generally due to harmonic distortion of the ADC or DAC.

As the “SFDR signal” is generated by the ADC or DAC, it cannot therefore be filtered by the passband of the analog filter in the receiver chain. Moreover, the “SFDR signal” is itself still subject to the Nyquist frequency. Whether the “SFDR signal” is “folded back” upon on a wanted signal or not can depend upon the input frequency of the blocking signal, the frequency of wanted signals, and the ADC sample rate. The strength of the “SFDR signal” can be affected by the strength of the blocking signal.

As discussed above, the ADC has a limited maximum sample rate; therefore it will also have a Nyquist Frequency. Indeed, there is a tradeoff between the SNR, the SFDR, a sample rate and a power consumption of an ADC. Newer design and process technologies are generally increasing the SNR and SFDR for ADCs at a given sample rate, but the SNR and SFDR for ADCs designed with lower sampling rates are typically better than those with higher sampling rates at equivalent power.

Therefore, there is a need in the art for a multi-carrier receiver that addresses at least some issues discussed above associated with a conventional multi-carrier receiver.

### SUMMARY

One aspect provides a system that has a first branch and a second branch. The system comprises a first intermediate frequency source of the first branch, and a first mixer coupled to the first intermediate frequency source. The system has a second intermediate frequency source of the second branch, and a second mixer coupled to the second intermediate frequency source. A frequency of the first intermediate frequency source is different than a frequency of the second intermediate frequency source. The system has an amplifier coupled to both an input of the first mixer and an input of the second mixer. A first component of the first branch of an analog to digital converter (“ADC”) is coupled the first mixer. A second component of the second branch of the ADC is coupled to the second mixer.

Another aspect provides a system having a first branch and a second branch. The system comprises an intermediate frequency source and a mixer coupled to the intermediate frequency source. A first branch amplifier of the first branch is coupled to the mixer, and a second branch amplifier of the second branch is also coupled to the mixer. A first analog to digital converter (“ADC”) of the first branch is coupled to the first branch amplifier, and a second ADC of the second branch coupled to the second branch amplifier. The first ADC and the second ADC each have different sampling rates.

Yet another aspect provides a multi-carrier receiver system having a first branch and a second branch. The system comprises a passband filter, a first intermediate frequency source of the first branch, and a first mixer coupled to the first intermediate frequency source. A frequency of the first intermediate frequency source is different than a frequency of the second intermediate frequency source. The system also comprises a second intermediate frequency source of the second branch, and a second mixer coupled to the second intermediate frequency source. An amplifier is coupled the first mixer, the second mixer and the passband filter. A first component of the first branch of the analog to digital converter (“ADC”) is coupled to the first mixer, and a second component of the second branch of the ADC coupled to the second mixer.

### BRIEF DESCRIPTION OF THE DRAWINGS

Reference is now made to the following descriptions taken in conjunction with the accompanying drawings, in which:

FIG. 1 is an illustration of a block diagram of a first embodiment of a multi-carrier receiver system; and

FIG. 2 is an illustration of a block diagram of a second embodiment of a multi-carrier receiver system.

### DETAILED DESCRIPTION

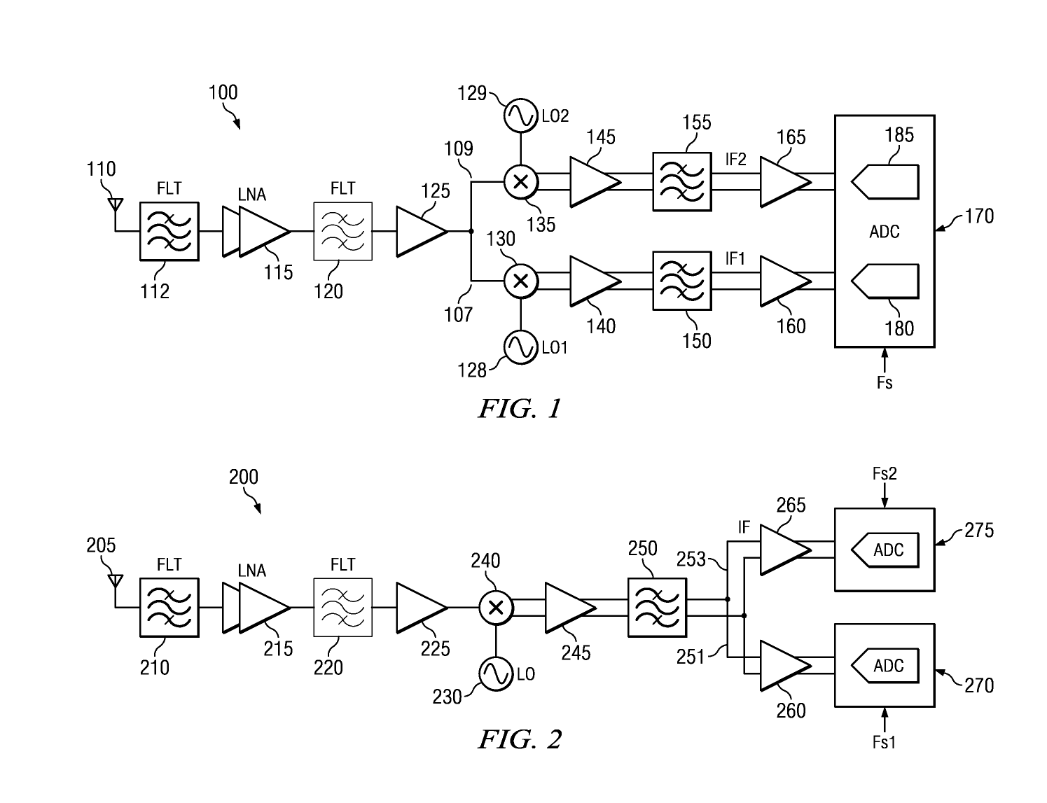

Turning to FIG. 1, illustrated is a first embodiment of a multi-carrier receiver system 100. Generally, in the system 100, as will be explained below, a received desired signal fₛ₁ is intermediate-frequency (“IF”) mixed into two distinct, but close, intermediate frequencies, a first IF-mixed in a first branch 107 and a second IF-mixed in a second branch 109 of the system 100. In one embodiment, an intermediate frequency can be defined as from 30 Megahertz (“MHz”) to 150 MHz.

A Nyquist frequency for the IF mixed signals of the first and second branches 107, 109 of the system 100 are the same, as the Nyquist frequency of each branch is a function of the digital sampling rate of an ADC 170, coupled to both the first and second branches 107, 109. However, advantageously, the harmonics of the received, mixed IF signals have shifted slightly in reference to one another and a desired signal, fₛ₁, when comparing the resulting IF-mixed waveforms of the first and second branches 107, 109. Therefore, the single Nyquist frequency of the ADC 170 produces two different folded spectrums, as the resulting aliasing of signals of the first and second branches 107, 109 are different. Therefore, advantageously, waveforms of either the first or second branch 107, 109 can be selected as having the lesser amount of an aliased signal harmonic blocking the desired signal _{fs1}.

In a further embodiment, “SFDR spurious”, generated by the ADC 170, will also have different potential overlaps on the first and second branches 107, 109, as it the ADC 170 is receiving two distinct IFs on the first and second branches 107, 109. The selected waveforms of either first or second branches 107, 109 can then be digitally processed and enhanced.

In the system 100, an antenna 110 is coupled to an input of a first filter (“FLT”) 112, a passband filter. A blocking frequency can also be passed by first FLT 112. An output of the FLT 112 is coupled to an input of a first low noise amplifier (“LNA”) 115. An output of the LNA 115 is coupled to an input of a second FLT 120. An output of the second FLT 120 is coupled to an input of a second amplifier 125. An output of the second amplifier 125 is coupled into both the first branch 107 and the second branch 109 of the system 100. In some embodiments, the second FLT 120 is not employed, and the output of first LNA 115 is directly coupled into the input of the second amplifier 125.

The first branch 107 includes an output of a first intermediate frequency source (“LOP) 128 coupled to an input of a first mixer 130. A second input of the first mixer 130 is coupled to an output of the second amplifier 125. An output of the first mixer 130 is coupled to an input of a third amplifier 140. An output of the third amplifier 140 is coupled to an input of a first intermediate filter (”IF1″) 150. An output of the IF1 150 is coupled to an input of a fourth amplifier 160. An output of the fourth amplifier 160 is coupled to an input of a first component 180 of the ADC 170. The first component 180 of the ADC 170 has a same sampling rate, Fₛ, as a second component 185 of the ADC 170. In one embodiment, a passband bandwidth in the system 100 is between Fₛ/3 and Fₛ/4.

The second branch 109 includes an output of a second intermediate frequency source (“L02”) 129 coupled to an input of a second mixer 135. A second input of the second mixer 135 is also coupled to the output of the second amplifier 125. An output of the second mixer 135 is coupled to an input of fifth amplifier 145. An output of the fifth amplifier 145 is coupled to an input of a second intermediate filter (“IF2”) 155. An output of the IF2 155 is coupled to an input of sixth amplifier 165. An output of the sixth amplifier 165 is coupled to an input of the second component 185 of the ADC 170. As discussed previously, the second component 185 of the ADC 170 has a same sampling rate, Fₛ, as the first component 180 of the ADC 170. Also, any given component of the system 100 may be programmable. Furthermore, the first and second components 180, 185 may be separate physical or logical ADCs that are programmed with a same sampling rate Fₛ within an integrated circuit of the ADC 170.

In one example employment of the system 100, a desired signal, fₛ₁, is a 1000 MHz signal, and there is a powerful “blocking” signal at 1020 MHz. In some embodiments, the “blocking” signal has a higher received power than the received power of the desired signal fₛ₁. The employed frequency of mixer L01 128 of the first branch 107 is 880 MHz. Therefore, at the input of the first component 180 of the ADC 170, the desired signal _{fs1} is at 120 MHz, and the blocking signal is at 140 MHz.

Furthermore, in this example, the Fₛ of the ADC 170, used by both the first component 180 and the second component 185, is 100 MSPS. Then, at an output of the first component 180 of the ADC 170, the desired signal is at 20 MHz, and the blocking signal is at 40 MHz.

The third harmonic (“HD3ₐ”) of the blocking signal of the first branch 107 is also at:

a) 3*140 modulo 100=420−80=20 MHz.

Therefore, for branch 107, the HD3 of the blocking interferes with the wanted signal.

However, in this example, if the intermediate frequency L02 145 of the second branch 109 is 885 MHz, the desired signal fₛ₁ at an input of the second component 185 of the ADC 170 is at 115 MHz, and the blocking signal is at 135 MHz. At an ADC 170 output, the desired signal fₛ₁ is at 15 MHz, and the blocking signal is at 35 MHz, and HD3_{b} of the blocking signal on the second branch 109 is at:

b) 3*135 modulo 100=405 modulo 100=5 MHz.

Therefore, HD3_{b} does not interfere with the desired signal, fₛ₁, which has been shifted to 15 MHZ. Therefore, the second component 185 of the ADC 170 can be used to receive and process the desired signal fₛ₁, as this allows for the non-blocked desired signal fₛ₁ to be further digitally processed and employed. Also, in further embodiments, additional branches of the system 100 can also be used, each with its own intermediate frequency generator (“LOₙ”). Generally, the system 100 allows for a high performance multi-carrier receiver using frequency selectivity and digital compensation techniques.

Turning now to FIG. 2, illustrated is a second embodiment of a multi-carrier receiver system 200. In the system 200, instead of having a plurality of intermediate frequency source generators with different frequencies, as is done in the system 100 by having different frequencies for L01 128 and L02 129, a sampling rate of an ADC itself is split into two separate ADCs, an ADC 270 and an ADC 275 each having “close” but distinct sampling rates from one another: Fₛ₁ and Fₛ₂, respectively.

The non-equal sampling rates, therefore, changes the “aliasing/wrap-around” frequency (i.e. changes the Nyquist frequency) for a first branch 251 and a second branch 253 having the ADCs 270, 275, respectively, which again changes where the aliased harmonics are going to be found for the first branch 251 and the second branch 253. Therefore, the non-blocked desired signal fₛ₁ may be selected either from the first branch 251 or the second branch 253 for further processing. Moreover, as the sampling rates are different for the ADCs 270, 275, the SFDR signal can be aliased into different locations within a frequency spectrum for the first branch 251 and the second branch 253.

In the system 200, an antenna 205 is coupled to an input of a first FLT 210, a passband filter. A blocking frequency can also be passed by first FLI 210. An output of the first FLT 210 is coupled to an input of the first LNA 215. An output of the first LNA 215 is coupled to an input of a second FLT 220. An output of the second FLT 220 is coupled to an input of a second amplifier 225. An output of the second amplifier 225 is coupled to an input of a mixer 240. A second input of the mixer 240 is coupled to an output of an IF frequency source (“LO”) 230. An output of the mixer 240 is coupled to an input of a third amplifier 245. An output of the third amplifier 245 is coupled to an input of a third filter 250. In some embodiments, second the FLT 220 is not employed, and the output of first LNA 215 is directly coupled into the input of the second amplifier 225.

An output of the second filter 250 is coupled to both the first branch 251 and a second branch 253. The first branch 251 includes a first branch amplifier 260. An output of the first branch amplifier 260 is coupled into an input of the first ADC 270, having its own sampling frequency, F_{S1} which, as discussed previously, is different from the sampling frequency Fₛ₂ of the ADC 275. The second branch 253 includes a second branch amplifier 265 and a second ADC 275, having its own sampling frequency, Fₛ₂, which, as discussed previously, is different from the sampling frequency Fₛ₁ of the ADC 270. Also, any given component of the system 200 may be programmable.

In a further embodiment, SFDR harmonics, generated by the ADCs 270, 275 will also have different aliasing on the first and second branches 265, 270, as each ADC 270, 275 has its own sampling rate.

In one example employment of the system 200, at radio frequencies, (i.e., before an employment of the mixer 240), the desired signal fₛ₁ is 1000 MHz, and there is also a large “blocking” signal at 1020 MHz. In some embodiments, the “blocking” signal has a higher received power than the received power of the desired signal fₛ₁. The mixer LO 230 frequency is 880 MHz. Therefore, at the input of the ADC 270 of branch 251, the desired signal fₛ₁ is at 120 MHz, and the blocking signal is at 140 MHz. In this example, Fₛ₁ of ADC 270 is 100 MSPS. Therefore, at the ADC 270 output of branch 251, the desired signal fₛ₁ is at 20 MHz, the blocking signal is at 40 MHz.

The HD3_{c} of the blocking signal is at:

c) 3*140 modulo 100=420−80=20 MHz.

Therefore, HD3_{c} of the blocking interferes with the desired signal fₛ₁.

However, continuing this example, if the Fₛ₂ of ADC 275 of the second branch 253 is 110 MSPS, at the ADC 275 output, the selected signal fₛ₁ is at 10 MHz, the blocking at 30 MHz.

The HD3_{d} of the blocking signal is at:

d) 110−3*140 modulo 105=110−420 modulo 110=110−90 MHz=20 MHz.

Therefore, HD3_{d} does not interfere with the desired signal fₛ₁. Therefore, the second ADC 275 of the second branch 253 can be used to receive the desired signal fₛ₁, as this allows for the non-blocked desired signal fₛ₁ to be further digitally processed and employed. Also, in further embodiments, additional branches can also be used, each with its own ADC having its own sampling rate. Generally, the system 200 allows for a high performance multi-carrier receiver using frequency selectivity and digital compensation techniques.

Those skilled in the art to which this application relates will appreciate that other and further additions, deletions, substitutions and modifications may be made to the described embodiments.

What is claimed is:

1. A system having a first branch and a second branch, comprising:
a first intermediate frequency source of said first branch;
a first mixer coupled to said first intermediate frequency source;
a second intermediate frequency source of said second branch, wherein:
a frequency of said first intermediate frequency source is different than a frequency of said second intermediate frequency source;
a second mixer coupled to said second intermediate frequency source;
an amplifier coupled to an input of said first mixer and an input of said second mixer;
a first component of said first branch of an analog to digital converter (“ADC”) coupled to said first mixer; and
a second component of said second branch of an ADC coupled said second mixer.

2. The system of claim 1, wherein said first component and said second component have a same sampling rate as one another.

3. The system of claim 1, wherein said intermediate frequency of said first intermediate frequency source and said intermediate frequency of said second intermediate frequency source are both from 30 MegaHertz (“MHz”) to 150 MHz.

4. The system of claim 1, wherein said system is a multicarrier receiver.

5. The system of claim 1, wherein a desired signal is further digitally processed from one of:
a) said first branch; or
b) said second branch.

6. The system of claim 5, wherein a harmonic that is generated by said ADC is not blocking said desired signal of said second branch.

7. A system having a first branch and a second branch, comprising:
an intermediate frequency source;
a mixer coupled to said intermediate frequency source;
a first branch amplifier of said first branch coupled to said mixer;
a second branch amplifier of said second branch coupled to said mixer;
a first analog to digital converter (“ADC”) of said first branch coupled to said first branch amplifier; and
a second ADC of said second branch coupled to said second branch amplifier, wherein:
said first ADC and said second ADC each have different sampling rates.

8. The system of claim 7, wherein an intermediate frequency of said intermediate frequency source is between 10 MHz and 100 MHz.

9. The system of claim 7, wherein said system is a multicarrier receiver.

10. The system of claim 7, wherein a desired signal is selected from one of said first ADC or said second ADC, wherein said first ADC has a Nyquist frequency that is different than that of said second ADC.

11. The system of claim 10, wherein a harmonic that is generated by said second ADC is not blocking said desired signal of said second branch.

12. The system of claim 7, further comprising wherein a harmonic generated by said first ADC is at a different frequency that a harmonic generated by said second ADC.

13. A multi-carrier receiver system having a first branch and a second branch, comprising:
a passband filter;
a first intermediate frequency source of said first branch;
a first mixer coupled to said first intermediate frequency source;
a second intermediate frequency source of said second branch, wherein:
a frequency of said first intermediate frequency source is different than a frequency of said second intermediate frequency source;
a second mixer coupled to said second intermediate frequency source;
an amplifier coupled said first mixer and said second mixer and said passband filter;
a first component of said first branch of said analog to digital converter (“ADC”) coupled to said first mixer; and
a second component of said second branch of said ADC coupled to said second amplifier.

14. The system of claim 13, wherein said first ADC and said second ADC have a same sampling rate as each other.

15. The system of claim 13, wherein an intermediate frequency of said first intermediate frequency source is between 10 MHZ and 100 MHZ.

16. The system of claim 13, wherein a desired signal is further processed from one of:
a) said first branch; or
b) said second branch.

17. The system of claim 16, wherein a harmonic that is generated by said ADC is not blocking said selected signal of said second branch.

18. The system of claim 13, wherein said first intermediate frequency and said second intermediate frequency differ by 5 Megahertz.

19. The system of claim 13, wherein a blocking frequency is passed by said passband filter.

20. The system of claim 13, wherein said blocking frequency has a higher received power than a received power of said desired signal.
